(19) United States
(12) Patent Application Publication
(10) Pub. No.: US 2004/0123881 A1
(43) Pub. Date: Jul. 1, 2004

(54) Method and apparatus for treatment of contaminated soil

(76) Inventor: Norman L. Desautels, Alida (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/172,022

(22) Filed: Jun. 17, 2002

(51) Int. Cl. B08B 3/00

(52) U.S. Cl. 134/25.1; 134/34; 134/36; 134/65; 134/79; 134/119

(57) ABSTRACT

The apparatus of the invention comprises a plurality of vessels, each vessel having a soil intake opening, a soil discharge opening, and a soil motivator associated therewith. The apparatus also has a liquid delivery system configured to deliver a liquid into at least one of the vessels, and a drainage system configured to collect the liquid and the contaminants. The vessels are arranged in sequence so that soil discharged from the discharge opening of one vessel is directly deposited into the intake opening of the next vessel. The method of the invention comprises the steps of: introducing the contaminated soil into a first vessel; washing the soil with a first liquid cleaning agent; passing the soil through a plurality of vessels in sequence wherein said first liquid cleaning agent is removed by a second liquid cleaning agent and water; draining said second liquid cleaning agent and water from the soil; and, rinsing the soil with water.

### TECHNICAL FIELD

This invention relates to treatment of contaminated soil, particularly to methods for remediating soil at the site of a spill of oil or other environmentally hazardous material and mobile apparatus for practising such methods.

### BACKGROUND

It is an unfortunate truth that when people handle materials which have the potential to damage the environment, sooner or later accidents will result in such materials being spilled on to the ground. For example, in oil fields, spills can occur as a result of leaking well heads. In this case, the fluids spilled are generally crude oil, salt water, or a mixture of the two called an “emulsion”. Fortunately, the deleterious effects of such accidents can be minimized if appropriate steps are timely taken to remove any contaminants from the soil upon which the spill has occurred. Cleaning contaminated soil is becoming an increasingly serious problem for business as environmental protection regulations become more strict.

One way to deal with spills is to load all of the contaminated soil into trucks and drive the soil to a reclaimer or “land farm”. At the reclaimer the soil is processed to remove contaminants. Contaminated soil is dumped into the open top of a vessel known as a reclaimer, where it is agitated by high pressure steam. Oil tends to collect at the top of the vessel and salt water near the mid section. After the oil and salt water have been skimmed off, the soil is further processed at a land farm. At a land farm the soil is placed in a clay pit and allowed to dry. The soil is turned periodically to allow sunlight to reach every portion of the soil. Ultraviolet light from the sun helps to break down hydrocarbons. Manure and straw may be mixed in with the soil to replace organic matter. Land farms may take years to process soil, and as a result, this method of dealing with spills is inefficient. Furthermore, land farms are few and far between. It is very expensive to haul tonnes of soil back and forth from spill sites to land farms in trucks.

There are various prior art apparatus and methods for treating soil at the site of a spill. This avoids the need to haul soil to a remote location for treatment. For example, U.S. Pat. No. 4,919,570 discloses a portable on-site soil treatment system that includes one or more soil treatment vessels cyclically connected to a pumping station and a treatment station. Fluid is pumped upwardly through the vessels to clean the soil. The vessels are tilted to dump the soil once the soil meets the necessary environmental standards.

U.S. Pat. No. 5,244,308 discloses a mobile apparatus for removing contaminants from soil. The soil is fed into a processor along with a liquid agent for separating the contaminants from the soil. The soil is then separated from the liquid agent containing the contaminants.

U.S. Pat. No. 5,637,154 discloses a method and portable apparatus for remediating soil using only water. The soil is fed into a hopper where it is screened and passed to a series of reactors by an auger. The soil is passed through the reactors by further augers. The number of washing stages is variable. The reactors are connected by transfer pipes in such a way that each subsequent reactor has a lower water level than the previous one.

U.S. Pat. No. 6,155,276 discloses a portable apparatus and method for removing soil contaminants that uses water and a biodegradable soap mixture. Soil, water and soap are fed into cylindrical chambers that have channels on the inside for capturing the soil. The chambers are arranged end to end and soil is moved between them by conveyors.

A general problem with current portable soil cleaning systems is that they are either slow (i.e. low throughput), or they themselves use large amounts of hazardous chemicals to remove the contaminants.

There exists a need for a mobile apparatus for efficiently treating contaminated soil at the site of a spill. There further exists a need for a method of soil treatment that is environmentally friendly, that is, one that does not use large amounts of toxic chemicals in removing contaminants from soil.

### SUMMARY OF INVENTION

One aspect of the invention provides an apparatus for treatment of soil that contains contaminants. The apparatus is made up of a plurality of vessels, each vessel having a soil intake opening and a soil discharge opening. Each vessel has a soil motivator associated therewith. The motivators are operable to move soil from the intake opening to the discharge opening. The apparatus also has a liquid delivery system configured to deliver a liquid into at least one of the vessels, and a drainage system configured to collect the liquid and the contaminants. The vessels are inclined so that the intake opening is at a lower level than the discharge opening. The vessels are arranged in sequence so that soil discharged from the discharge opening of one of the vessels is directly deposited into the intake opening of the next vessel.

Each of the intake openings is preferably near a first end of one of the vessels. Each of the discharge openings is preferably near a second opposite end of one of the vessels. The second end of one vessels is preferably above the first end of the next vessel, so that soil exiting the discharge opening of one vessel falls directly into the intake opening of the next vessel.

The vessels are preferably inclined at angles between 10 and 40 degrees, and more preferably between 25 and 30 degrees. The second end of one vessels is preferably above the first end of the next vessel.

The soil motivators preferably comprise rotatable shafts with a plurality of paddles attached thereto. The paddles may be symmetrically disposed around the rotatable shafts. The paddles may extend radially outward from the shafts in pairs. Adjacent pairs of paddles may be perpendicular to each other.

The paddles are oriented so that when the shafts are rotated in a forward sense (the forward sense is clockwise when looking out of the drum through the discharge opening), the paddles move soil towards the discharge opening.

The motivator preferably further comprises a motor operably coupled to the shaft. The motor is capable of rotating the shaft in a forward sense.

The vessels preferably comprise cylindrical drums.

The first end of at least one of the drums is preferably closed and the second end of at least one of the drums is preferably open.

The drainage system may comprise a screened portion on an underside of at least one of the vessels.

The screened portion is preferably adjacent to the discharge opening. The screened portion preferably has a mesh size in the range of 20 to 80 mesh.

The drainage system may further comprise at least one slot on the underside of at least one of the drums. The slot is preferably oriented generally horizontally along a side of the drum, the slot extending from the screened portion towards the first end. The drainage system may alternatively comprise a series of holes in the underside of at least one of the drums.

The paddles may have replaceable wear plates attached thereon.

The motivator may comprise a screened cylinder attached to a rotatable shaft. The screened cylinder may have a plurality of paddles therein.

The drainage system may comprise a plurality of slots on the underside of at least one of the drums.

The apparatus may further comprise a trailer having an intake conveyor and a discharge conveyor mounted thereon. The drums may be positioned on the trailer so that soil placed on the intake conveyor deposits soil into a first drum, and soil exiting the last drum is deposited on the discharge conveyor.

The drainage system may comprise a skimming system, the skimming system comprising gutters and skimming plates, wherein the liquid and contaminants are delivered to the gutters and flow over the skimming plates, while any remaining soil mixed in with the liquid and contaminants is caught by the skimming plates.

An alternative aspect of the invention provides a single vessel in which soil may be treated.

Another aspect of the invention provides a method of treating soil that contains contaminants. The method comprises the steps of: inserting the contaminated soil into a first vessel; washing the soil with a first liquid cleaning agent; passing the soil through a plurality of vessels in sequence wherein said first liquid cleaning agent is removed by a second liquid cleaning agent and water; draining said second chemical and water from the soil; and, rinsing the soil with water.

Further features and advantages of the invention are described below.

### BRIEF DESCRIPTION OF DRAWINGS

In drawings which illustrate non-limiting embodiments of the invention:

FIG. 1a is a top plan view of apparatus according to a preferred embodiment of the invention;

FIG. 1b is a right side elevation view of the apparatus of FIG. 1a;

FIG. 1c is a left side elevation of the apparatus of FIG. 1a;

FIG. 2 is a rear elevation view of the apparatus of FIG. 1a with a rock washer attached to the side of the trailer.

FIG. 3 is a perspective view of one of the drums according to a preferred embodiment of the invention;

FIG. 4 is a perspective view of one of the drums according to a preferred embodiment of the invention, showing drip trays that form part of a drainage system;

FIG. 5 is a perspective view of one of the drums according to a preferred embodiment of the invention, showing a rotating screened drum inside of the forward portion of the drum;

FIG. 6 is a right side elevation view of the drum of FIG. 5, with an expanded view of the intersection of the rearward and forward portions of the drum;

FIG. 7 is a perspective view of one of the drums according to a preferred embodiment of the invention, showing a rotating screened drum inside the entire length of the drum;

FIG. 8 is an end view of a funneling member used to guide soil into the drums;

FIG. 9 is a side view of the funneling member of FIG. 8;

FIG. 10 is a side view of a chute used to connect the fourth drum to the fifth drum;

FIG. 11a is a side view of a set of paddles mounted on a shaft constructed according to a preferred embodiment of the invention;

FIG. 11b is a side view of a larger set of paddles mounted on a shaft constructed according to a preferred embodiment of the invention;

FIG. 12a is an exploded view of one of the paddles, showing a wear plate which may be attached thereon;

FIG. 12b shows the paddle of FIG. 12a with the wear plate attached thereon;

FIG. 13 is an end view of one drum according to a preferred embodiment of the invention, showing a motor and a chain used to turn a sprocket;

FIG. 14 is a perspective view of a gutter with a skimmer plate therein;

FIG. 15a is an end view of the gutter and skimmer plate of FIG. 14 with the skimmer plate lowered;

FIG. 15b is an end view of the gutter and skimmer plate of FIG. 14 with the skimmer plate raised; and,

FIG. 16 is a perspective view of a sump.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

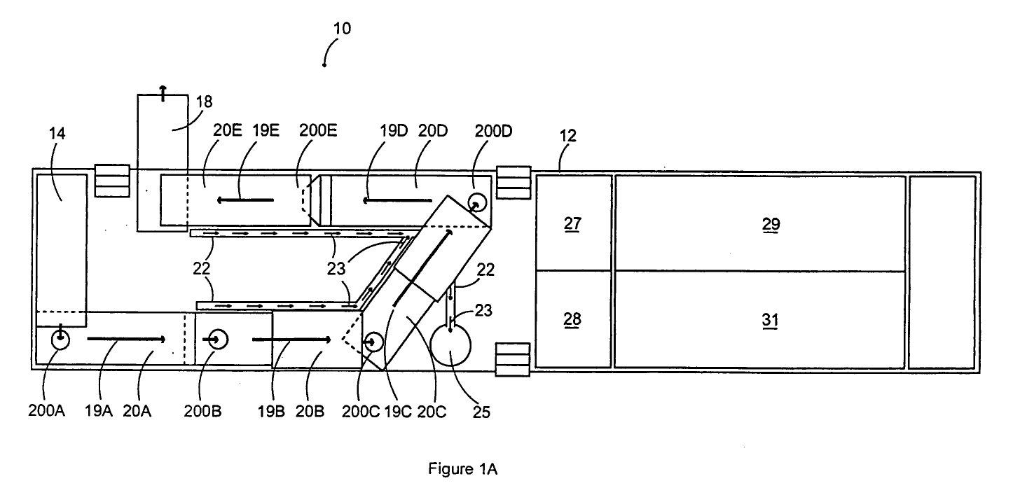

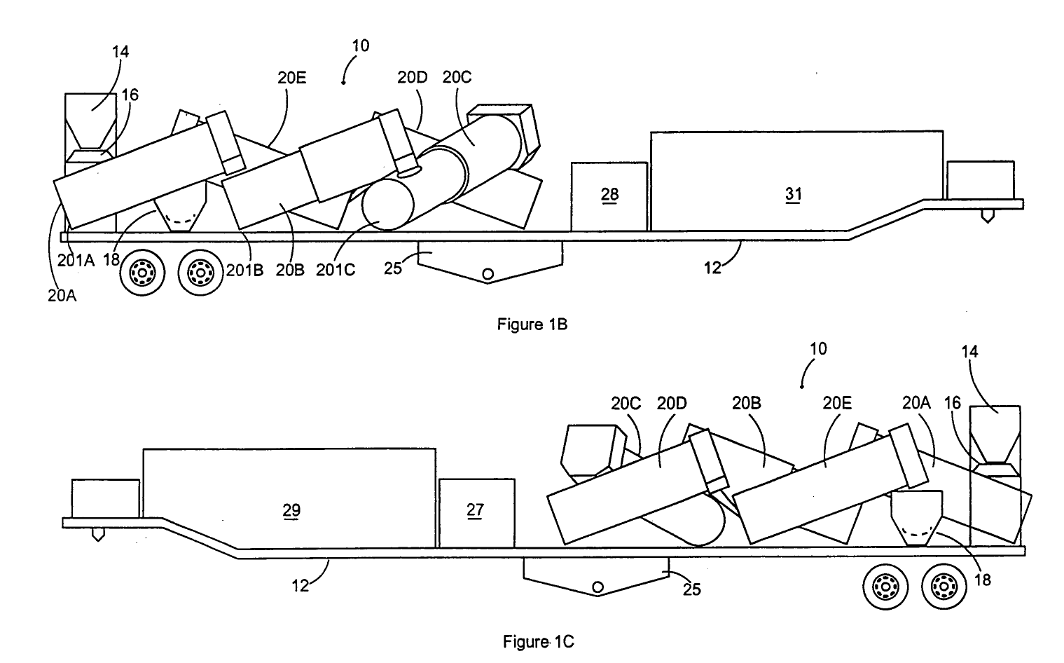

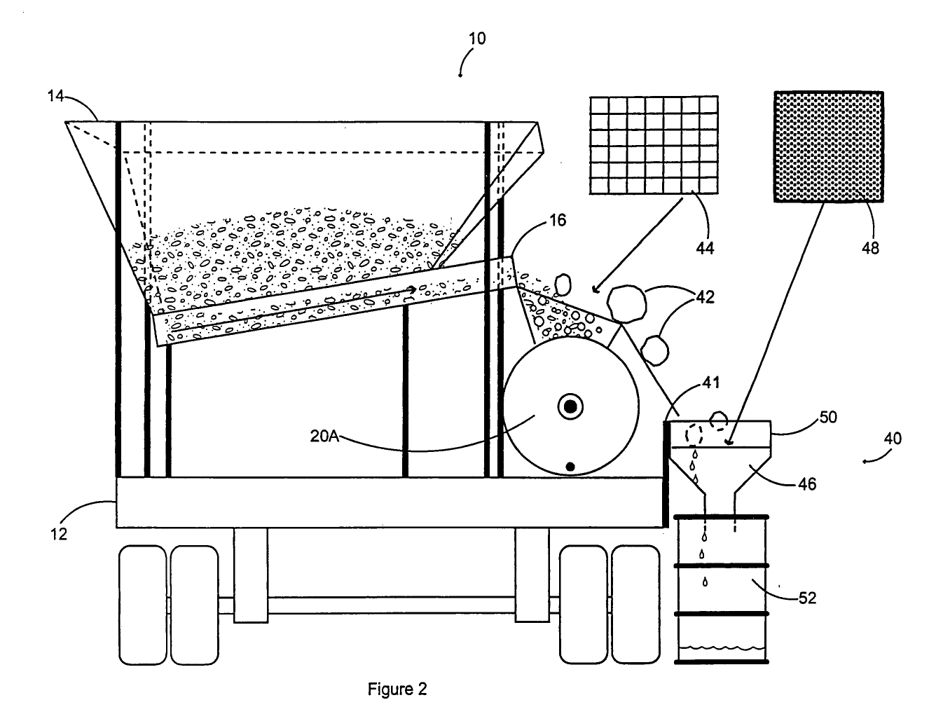

The invention provides an apparatus 10 and method for removing contaminants from soil. Apparatus 10 preferably includes a trailer 12 as shown in FIGS. 1a, 1b, 1c and 2 so that it can be easily taken to the site of a spill where it can be used to clean contaminated soil. Apparatus 10 comprises a series of drums 20. Soil is moved continuously through drums 20 of apparatus 10 along a path 13 in the direction indicated by arrows 19. As it passes through drums 20, the soil is washed with liquids, which may include first and second liquid cleaning agents and water. Each drum 20 is inclined so that soil and liquid tend to accumulate at its lower end 201.

Drums 20 are preferably all inclined at substantially the same angle, with one end of each drum 20 positioned above the next drum 20. The angle of drums 20 is preferably in the range of 10 and 45 degrees, most preferably in the range of about 25 to 30 degrees. Each drum 20 has a soil motivator 17. Soil motivator 17 urges soil up and eventually out of drum 20 at a discharge opening 202. Due to the incline of drum 20, fluids tend to drain out of the soil before it reaches discharge opening 202. As soil exits one drum 20, it falls directly into an intake opening 200 of the next drum 20 along path 13. Some drums 20 have a drainage system, as described below, to remove liquids from the soil and the drum 20 before the soil leaves drum 20. Such liquids are carried to a sump 25 by a gutter 22.

FIGS. 1a, 1b, 1c and 2 show a soil treatment apparatus 10 according to a preferred embodiment of the invention. This embodiment is described in detail herein so as to fully explain the best mode of the invention currently contemplated by the inventor. The embodiment described herein should be considered to be an example only. Apparatus 10 comprises a hopper 14, intake conveyor 16, five drums 20A, 20B, 20C, 20D and 20E, and a discharge conveyor 18.

In operation, soil is fed continuously into hopper 14 from where it is deposited onto intake conveyor 16. Alternatively, a vacuum hose and tank (not shown) could be used to suck soil and contaminants up from the ground into hopper 14. Intake conveyor 16 deposits soil into first drum 20A through an intake opening 200A. There may be a grate 44 over intake opening 200A to prevent large rocks from entering first drum 20A, as discussed below.

Each drum 20 has a forward direction as indicated by arrow 19 (see FIG. 1a). Soil is moved in sequence through first through fifth drums 20A-20E in the direction of arrows 19. As the soil moves through drums 20, liquids are added, as described below. In each drum 20, a soil motivator 17 agitates the soil along with the liquids and urges the soil in the “forward” direction indicated by arrow 19.

Apparatus 10 is configured to process a steady flow of contaminated soil.

FIGS. 3 to 7 illustrate the basic structure of drums 20. Each drum 20 has an intake opening 200 near its lower end 201, which is covered by end plate 204. The upper end 203 is open and forms a discharge opening 202. End plate 204 has a drain hole 206 near its bottom edge. During operation, drain hole 206 is plugged by a drain plug (not shown). There may be an access hatch (not shown) provided on the top of drum 20, to allow for maintenance and inspection when the apparatus is not in operation.

First drum 20A may have various forms but preferably comprises an elongated cylinder with a lower end 201A covered by an end plate 204A, and an upper end 203A, as shown in FIG. 3. Intake opening 200A is formed in the top of first drum 20A near lower end 201A. Upper end 203A is open and forms discharge opening 202A.

A first liquid cleaning agent is introduced into first drum 20A from first liquid cleaning agent tank 27 by means of a hose (not shown). The first liquid cleaning agent is preferably a Xylene-based cleanser.

First drum 20A is inclined so that the soil and the first liquid cleaning agent tend to accumulate at the bottom of first drum 20A near end plate 204A. First drum 20A has a soil motivator 17 therein which agitates the soil and first liquid cleaning agent. The motivator urges the soil up drum 20A towards discharge opening 202A, while allowing the first liquid cleaning agent to drain back to the bottom of first drum 20A to form a pool 15 of liquid. Motivator 17 preferably comprises a rotatable shaft 224A. Shaft 224A may be rotated by any suitable means, but is preferably turned by a motor 220, as described below. In the illustrated embodiment shaft 224A is rotatably supported at its lower end by suitable bearings in a shaft receiving hole 208A through the middle of end plate 204A.

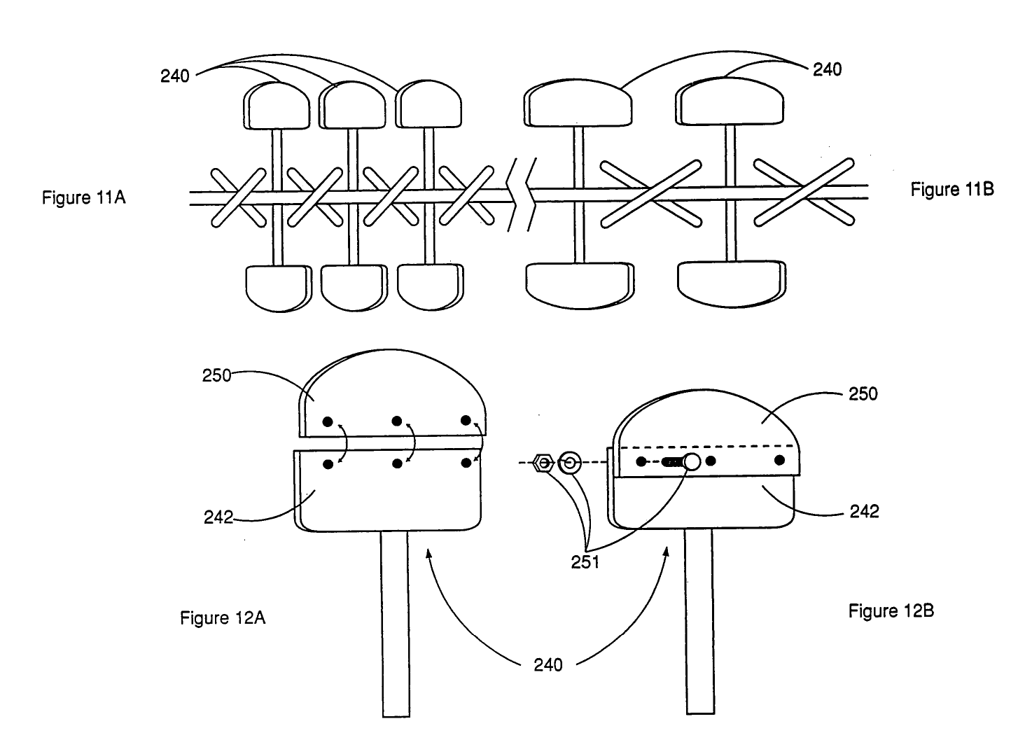

Shaft 224A preferably has a set of paddles 240A attached thereto, as shown in FIGS. 3 and 11a. It would be possible to use an auger in place of paddles 240A. However, paddles 240A allow liquid to more readily seep back towards the bottom of first drum 20A as the soil is moved upwards than would an auger. This is desirable because contaminants become dissolved in the liquid. By separating the liquid from the soil some of the contaminants are removed. Furthermore, an auger would likely require more power to turn than paddles 240A (since an auger would force soil continuously towards end 203A, while paddles 240A allow soil to move from one paddle 240 to the next). Paddles 240A are spaced apart around shaft 224A.

In the preferred embodiment shown in the drawings, paddles 240A extend radially outwardly from shaft 224A in pairs, although other arrangements of paddles 240A are possible. The paddles 240A of each pair extend from shaft 224A in opposite directions. Adjacent pairs of paddles 240A are preferrably oriented perpendicularly relative to one another. Each paddle 240A has a blade 242A that is at an angle of approximately 45 degrees to shaft 224A. Blades 242A of one pair of paddles 240A are at opposite angles to shaft 224A. Paddles 240A are spaced apart so that blades 242A of adjacent pairs just overlap. Blades 242A are shaped and sized to pass within a short distance, for example, within about 1/16″ to ⅛″ or so (1.6-3.2 mm) of the interior walls of drum 20A when shaft 224A is placed therein.

As shown in FIG. 3, one end of shaft 224A is inserted through a shaft receiving hole 208A in endplate 204A, while the opposite end is supported by a shaft support (not shown) at discharge opening 202A. The shaft support has a bearing (not shown) therein to allow shaft 224A to rotate freely.

When shaft 224A is rotated, any soil in first drum 20A is agitated by paddles 240A. The orientation of blades 242A is such that when shaft 224A is rotated in a forward sense, (clockwise when looking out through discharge opening 202A), soil is moved upward and out through discharge opening 202A, while the majority of liquids in first drum 20A drain back into pool 15 and remain in first drum 20A.

Some of the first liquid cleaning agent will remain with the soil when it leaves first drum 20A. Preferably a majority of the first liquid cleaning agent drains back into pool 15 as the soil is carried upward through first drum 20A. First liquid cleaning agent may be relatively expensive, so it is desirable to retain the majority of the first liquid cleaning agent in first drum 20A. Preferably only small amounts of the first liquid cleaning agent must be replenished as soil is processed.

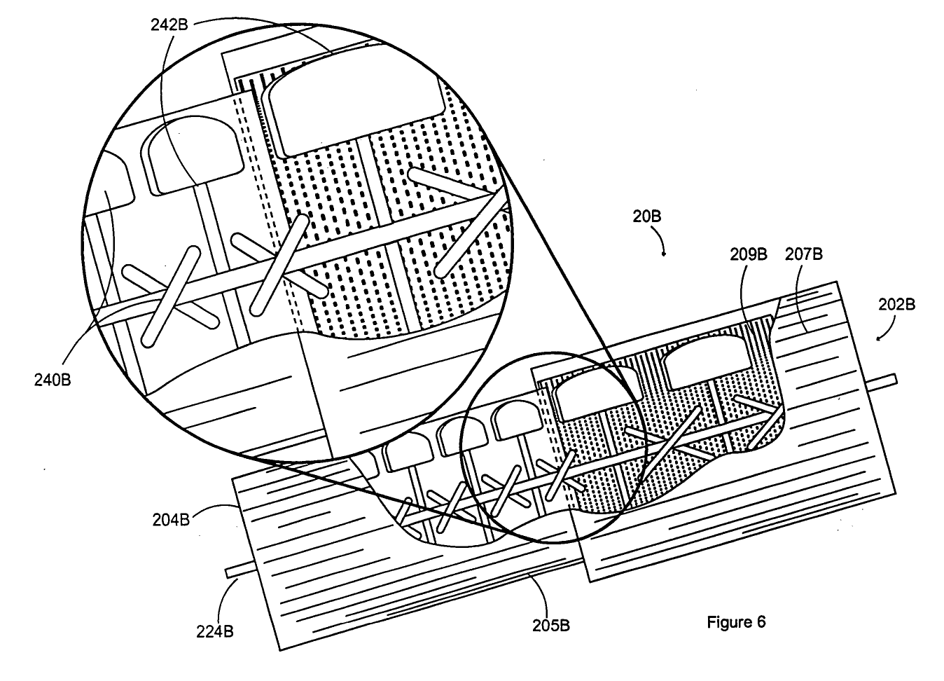

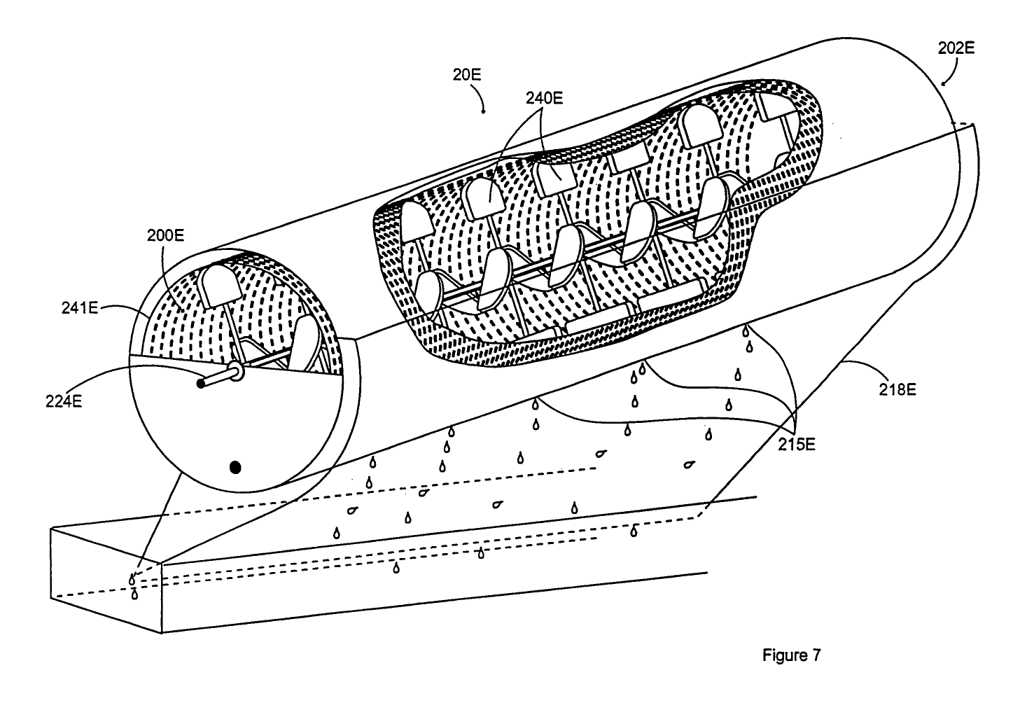

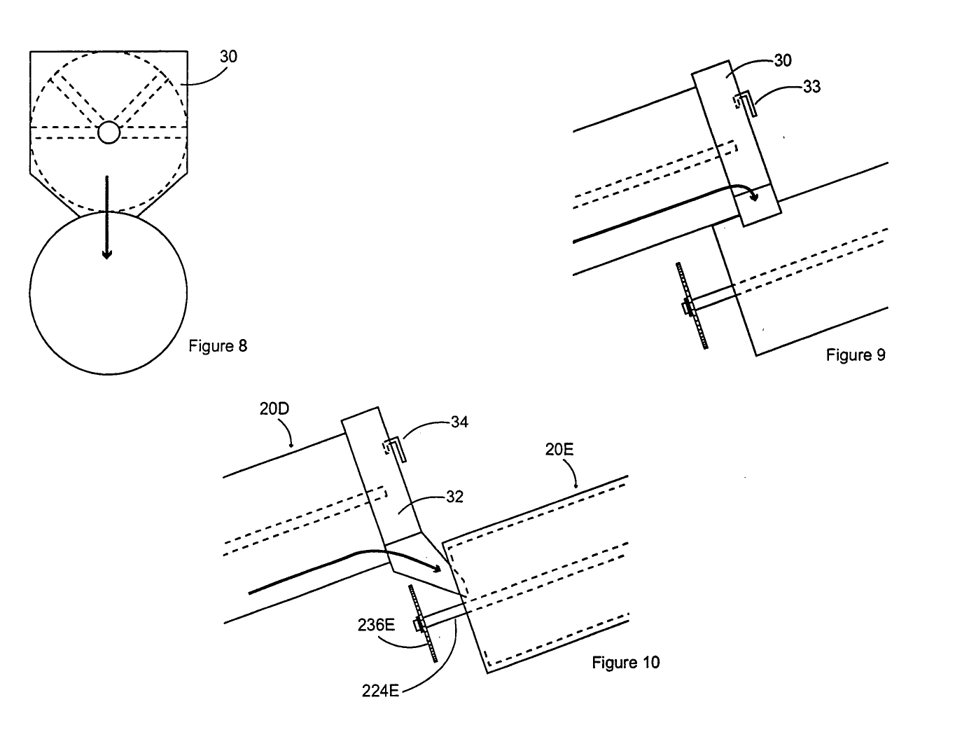

Once the soil leaves discharge opening 202A of first drum 20A, it falls directly into intake opening 200B of second drum 20B. There may be a funneling member 30 connecting discharge opening 202A and intake opening 200B, as shown in FIGS. 8 and 9.

FIGS. 8 and 9 show a funneling member 30 which may be fitted over discharge opening 202 of a drum 20 to guide soil into intake opening 200 of the next drum 20. The opening at the bottom of funneling member 30 is placed in intake opening 200. A liquid supply 33 may be provided in funneling member 30 so that water or the first or second liquid cleaning agents may be added to the soil as it passes through funneling member 30.

Water from fresh water tank 29 is added to second drum 20B by means of a hose (not shown) connected to liquid supply 33, along with the soil. The water may be heated before being added to second drum 20B, to increase its ability to accept solutes. Water may be supplied to drums 20C, 20D and 20E in a similar fashion.

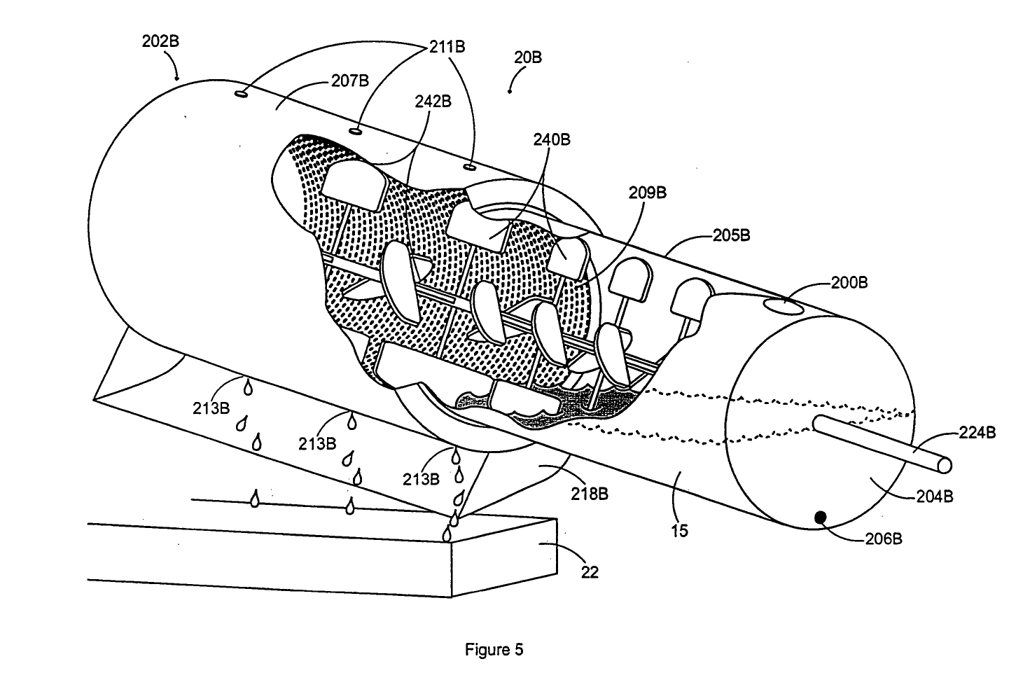

Second drum 20B comprises a rearward portion 205B and a forward portion 207B as shown in FIGS. 5 and 6. Rearward portion 205B has a diameter equal to that of first drum 20A. Forward portion 207B has a diameter approximately 1 to 2 inches greater than that of rearward portion 205B to accommodate a rotating screened drum 209B, as described below. Rearward portion 205B of second drum 20B functions in much the same way as first drum 20A, except that rearward portion 205B has a liquid removal system that comprises part of a drainage system for second drum 20B.

Shaft 224B extends through the entire length of second drum 20B. Paddles 240B in rearward portion 205B are the same as paddles 240A of first drum. Paddles 240B in forward portion 207B are shown in FIG. 11b, and are larger than paddles 240B in rearward portion 205B. Rotating screened drum 209A is attached to the outer edges of blades 242B of forward portion 207B. Rotating screened drum 209A preferably has a mesh size of approximately 20 to 80 mesh. Rotating screened drum 209B preferably overlaps rearward portion 205B by approximately 1/16″ to 3/16″ (1.5 mm to 4.5 mm) and extends forward to approximately 1″ (25 mm) beyond discharge opening 202B. Forward portion 207B may have sprayers 211B along an upper portion thereof. Forward portion 207B has slots 213B along a lower portion thereof which comprise the liquid removal system of forward portion 207B, as described below.

In operation, soil and liquids enter intake opening of drum 20B and are urged forward through rearward portion 205B. A significant portion of the liquids will drain back into pool 15 as the soil and liquids are agitated by paddles 240B. The soil and any remaining liquids then pass into rotating screened drum 209B. As seen in the expanded circle in FIG. 6, rotating screened drum 209B is slightly larger than, and partially overlaps, rearward portion 205B, so that none of the soil will fall between rearward portion 205B and rotating screened drum 209B. The soil is urged forward through forward portion 207B, and most of the liquids migrate through the rotating screened drum 209B and out slots 213B, as described below. Once the soil exits discharge opening 202B it falls out of screened drum 209B into intake opening 200C of third drum 20C, possibly with the assistance of funneling member 30.

The drainage system of second drum 20B comprises a liquid removal system and a liquid collection system. The liquid removal system comprises slots 213B in the underside of forward portion 207B. Sprayers 211B spray water (which may be heated) down through rotating screened drum 209B. The water from the sprayers keeps the screened drum 209B from clogging. The majority of the liquids and water from sprayers 2111B drains through slots 213B.

The liquid collection system of second drum 20B preferably comprises right drip tray 218B and gutter 22. As best seen in FIG. 5, right drip tray 218B is configured to collect any liquid exiting second drum 20B through slots 213B and deliver it to gutter 22. Gutter 22 collects liquid from drums 20 and delivers it to sump 25.

Soil is agitated and moved forwards and upwards through second drum 20B by paddles 240B, while most of the liquid drains into gutter 22. The liquid carries away with it most of the remaining first liquid cleaning agent. Soil exits second drum 20B through discharge opening 202B and falls from rotating screened drum 209B into intake opening 200C of third drum 20C, possibly with the assistance of funneling member 30. A mixture of a second liquid cleaning agent from second liquid cleaning agent tank 28, and water from fresh water tank 29 are added to third drum 20C by means of hoses (not shown) connected to liquid supply 33, along with the soil. The water may be heated. The second liquid cleaning agent is biodegradable, and preferably comprises citric acid. The second liquid cleaning agent may be derived from orange peelings.

The soil and liquid mixture passes through third drum 20C in substantially the same way as it passes through second drum 20B. The drainage system of third drum 20C is preferably substantially the same as that of second drum 20B. By the time the soil and liquid mixture reaches discharge opening 202C of third drum 20C, there is typically no detectable amount of the first liquid cleaning agent or the contaminants remaining mixed in with the soil.

Fourth and fifth drums 20D and 20E are used to rinse the majority of the second liquid cleaning agent from the soil and drain most of the water from the soil. As the soil and liquid mixture is deposited into intake opening 200D of fourth drum 20D, more fresh water is added from fresh water tank 29 by means of a hose (not shown) connected to liquid supply 33.

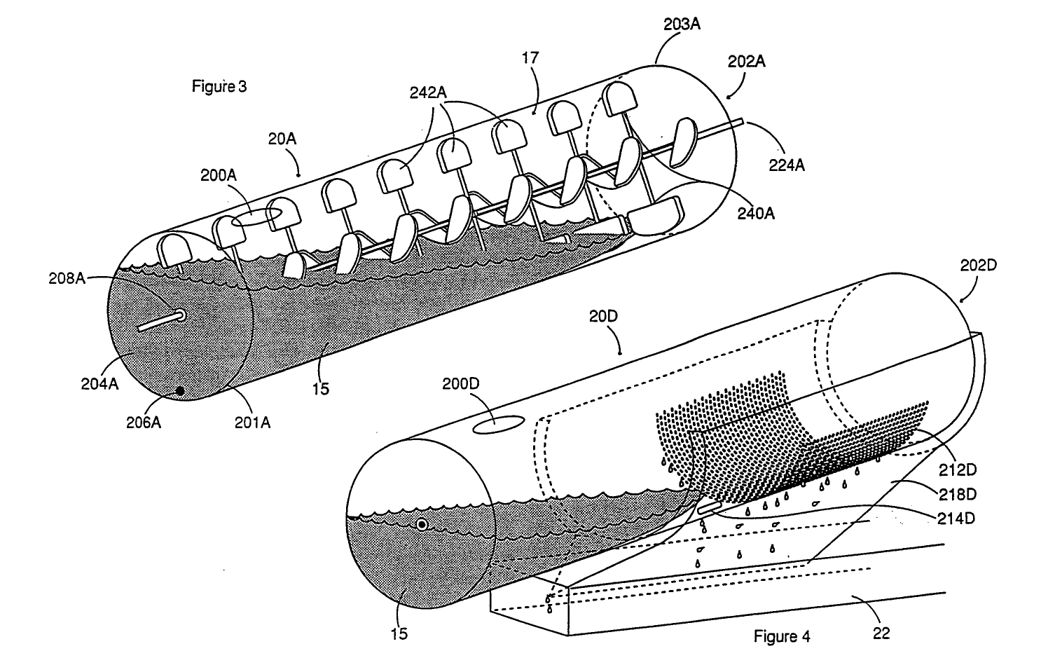

Fourth drum 20D is shown in FIG. 4, and functions in much the same way as first drum 20A, except that fourth drum 20D has a drainage system, and water from fresh water tank 29 is added to fourth drum 20D by means of a hose (not shown) connected to liquid supply 33, along with the soil. The water may be heated before being added to fourth drum 20D, to increase its ability to accept solutes.

The drainage system of fourth drum 20D comprises a liquid removal system and a liquid collection system. The liquid removal system of fourth drum 20D preferably comprises a fine mesh screen 212D and a slot 214D. Screen 212D forms the underside of fourth drum 20D in a portion near its upper end 203D. Screen 212D is fine enough to retain soil particles while letting liquids pass through. For example, a suitable mesh size for screen 212D is in the range of 20 to 80 mesh. Slot 214D extends along the right side (when looking in direction of arrow 19D) of drum 20D. Slot 214D is oriented generally horizontally when fourth drum 20D is in its inclined position. In the preferred embodiment slot 214D extends from screen 212D partway to end plate 204D. As paddles 240D rotate clockwise (when looking in direction of arrow 19B), soil is pushed up the left side of drum 20D, away from slot 214D. Liquids, however, will collect more or less in the middle of drum 20D. Any liquids above the level of slot 214D will drain through slot 214D.

Liquid collection system of fourth drum 20D preferably comprises left drip tray 216D, right drip tray 218D and gutter 22. As best seen in FIG. 4, left and right drip trays 216D and 218D are configured to collect any liquid exiting fourth drum 20D through screen 212D or slot 214D and deliver it to gutter 22.

A chute 32 is attached to discharge opening 202D. Chute 32 connects discharge opening 202D of fourth drum 20D to intake opening 200E of fifth drum 20E. Chute 32 is different from funneling member 30 to accommodate the structure of fifth drum 20E, as described below.

FIG. 10 shows how chute 32 connects fourth drum 20D to fifth drum 20E. One end of chute 32 is fitted over discharge opening 202D of fourth drum 20D to receive soil. The other end of chute 32 is fitted into intake opening 200E of fifth drum 20E to deliver soil into fifth drum 20E. A hose (not shown) delivers water from water tank 29 to a sprayer 34 in chute 32. Sprayer 34 delivers a pressurized stream of water down chute 32 so that chute 32 does not get clogged with soil.

FIG. 7 shows the structure of fifth drum 20E. Drum 20E is similar to the forward portions of drums 20B and 20C. In addition to paddles 240E, shaft 224E has a screened cylinder 241E mounted thereon. Screened cylinder 241E has a diameter slightly less than the interior diameter of fifth drum 20E. Soil is introduced into the interior of screened cylinder 241E through intake opening 200E which is formed through the upper portion of end plate 204E. The liquid removal system of fifth drum 20E preferably comprises slots 215E in the bottom thereof. Liquid collection system of fifth drum 20E preferably comprises drip trays 216E, 218E attached to the sides thereof to direct drained liquid into gutter 22. Paddles 240E are preferably larger than other paddles 240A-D, and shaft 224E may be rotated faster than other shafts 224A-D for increased drainage of liquids from soil in fifth drum 20E.

After passing through fifth drum 20E the soil, which is now clean but may have some water mixed in with it, exits fifth drum 20E through discharge opening 202E and is dumped onto discharge conveyor 18. Discharge conveyor 18 deposits the clean (and possibly wet) soil on to the ground, or into a suitable soil transportation device (e.g. a truck) for return to the environment. Discharge conveyor 18 may be stored on trailer 12, as indicated by dotted lines in FIG. 1a.

Returning briefly to FIG. 1a, gutter 22 runs just below the left side of second through fifth drums 20B-E. Gutter 22 is sloped so that liquids flow in the direction of arrows 21. Reference numeral 23 in FIG. 1a indicates skimmer plates 23, the operation of which is best described with reference to FIGS. 14, 15a and 15b.

As seen in FIGS. 14, 15a and 15b, gutter 22 has slots 24 into which removable skimmer plates 23 may be inserted. Skimmer plates 23 prevent any fine soil particles that escape drums 20 from reaching sump 25. Liquid builds up upstream of skimmer plates 23, and then flows over skimmer plates 23, while solid particles are collected at the bases of skimmer plates 23.

As seen in FIG. 16, gutter 22 drains into sump 25 through a fine screen 26. Screen 26 is designed to remove any remaining solid particles from the liquid entering sump 25. Screen 26 preferably has a mesh size of 80 to 120 mesh. Liquid from sump 25 is pumped into holding tank 31, where it is stored until it can be hauled by a tank truck to an appropriate processing facility, such as a digester.

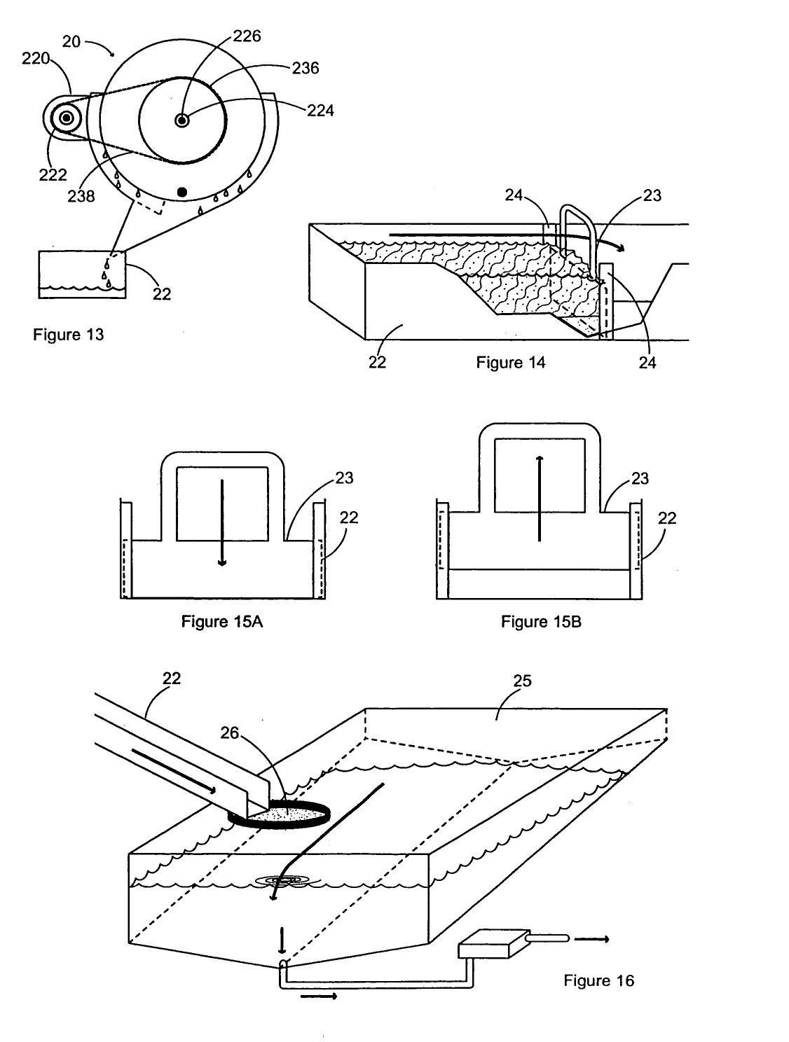

As shown in FIG. 13, in the preferred embodiment, shafts 224 are each turned by a suitable drive means. In the illustrated embodiment the drive means comprises a motor 220. Motor 220 has a driving sprocket 222 attached thereto. Each drum 20 has a shaft 224 extending through the center thereof and out shaft receiving hole 208, and a bearing assembly 226. Bearing assembly 226 serves to allow shaft 224 to rotate freely in shaft receiving hole 208. Driven sprocket 236 is non-rotatably attached to shaft 224.

Driving sprocket 222 is operably coupled to driven sprocket 236 by means of a chain 238. When in operation, motor 220 turns driving sprocket 222. This rotational motion is transferred to driven sprocket 236, and thus shaft 224, through chain 238. Driving sprocket 222 may be selected to be smaller than driven sprocket 236 so that shaft 224 rotates much slower than motor 220. It will be apparent to one skilled in the art that there are many other functionally equivalent ways to turn the shafts 224, any of which may be used.

Shaft 224E is turned by motor 220E in the same way as for drums 20A-D. However, shaft 224E is longer, and extends farther away from end plate 204E, than other shafts 224A-D This allows sprocket 236E to keep clear of chute 32. Sprocket 236E is smaller than sprockets 236A-D so that shaft 224E rotates faster than shafts 224A-D.

FIGS. 12a and 12b show how a replaceable wear plate 250 may be attached as the end of a blade 242 by means of a nut and bolt assembly 251. As soil is fed through apparatus 10, blades 242 may become worn. Wear plates 250 simplify maintenance by allowing replacement of the ends of blades 242, rather than replacement of the entire paddle 240, which is preferably permanently attached, for example by welding, to shaft 224. The ends of blades 242 are the portions that will likely wear out first.

Returning to FIG. 2, a rock washer 40 may be used in conjunction with the drums 20. Rock washer 40 may be attached to trailer 12 adjacent first drum 20A by means of bracket 41. The position of rock washer 40 relative to drums 20 can be seen in FIG. 2. Alternatively, rock washer 40 may be mounted on the rear of trailer 12, so that it may remain attached to trailer 12 during transport. Occasionally, large rocks 42 that could damage drums 20 may fall into hopper 14. To prevent rocks 42 from entering drums 20, a grate 44 is placed at the end of intake conveyor 16, above intake opening 200A of first drum 20A. Grate 44 is angled so that rocks 42 fall into rock washer 40.

Rock washer 40 comprises funnel 46, screen 48 and walls 50. Rocks 42 are dropped onto screen 48 and walls 50 prevent rocks 42 from falling to the ground. Rocks 42 may be washed while sitting on screen 48. Any liquid used in washing rocks 42 falls through screen 48 into funnel 46 to be collected in bucket 52. Rocks 42 may be returned to the ground when they are clean.

As shown in FIG. 1a, drums 20 may be arranged on trailer 12 so that path 13 has a generally “U” shape when viewed form above. This provides a reasonably compact and easily transportable configuration.

As will be apparent to those skilled in the art in the light of the foregoing disclosure, many alterations and modifications are possible in the practice of this invention without departing from the spirit or scope thereof. For example:

a different number of drums could be used;

the drums need not be cylindrical—they could have a rectangular cross-section as long as the motivators are adapted to move soil along the rectangular drums, for example, by moving the paddles longitudinally up along the bottoms of the drums;

other drive means may be provided to drive the soil motivators;

one motor or engine could drive multiple soil motivators by way of a suitable power transmission system;

the motors may be operably connected to the shaft in a number of different manners;

the shafts may be turned by means other than the motors described above;

the motivators may comprise augers with interrupted blades;

the first and second liquid cleaning agents could comprise chemicals other than those described herein having similar characteristics;

the first and second liquid cleaning agents could both comprise the same biodegradable agent;

the intake and discharge conveyors could be replaced with chutes;

the trailer could have sides and a roof for use in cold temperatures;

apparatus according to the invention could comprise separate trailers, one trailer for the drums and another trailer for the tanks;

apparatus according to the invention could be mounted or placed on a barge for use in cleaning up shoreline spills;

the invention could be practiced as a stationary treatment facility with larger drums, storage tanks, gutters and sump;

the screens may be replaced with screens having a different mesh size for use with different types of soil.

Accordingly, the scope of the invention is to be construed in accordance with the substance defined by the following claims.

What is claimed is:

1. An apparatus for treatment of soil that contains contaminants, the apparatus comprising:
a plurality of vessels, each of said vessels having a soil intake opening and a soil discharge opening;
a plurality of soil motivators, each of said motivators associated with one of said vessels, said motivators operable to move soil through the associated vessel from said intake opening to said discharge opening;
a liquid delivery system configured to deliver a liquid into at least one of said vessels; and
a drainage system configured to collect said liquid and said contaminants;
wherein said vessels are inclined so that the intake opening is at a lower level than the discharge opening, and said vessels are arranged in sequence so that soil discharged from the discharge opening of one of said vessels falls into the intake opening of the next said vessel.

2. The apparatus of claim 1 wherein each of said intake openings is near a first end of one of said vessels, and each of said discharge openings is near a second end of one of said vessels.

3. The apparatus of claim 2 wherein the vessels are inclined at angles in the range of 10 to 40 degrees, and the second end of one of said vessels is above the first end of the next said vessel.

4. The apparatus of claim 3 wherein the angles of the vessels is in the range of 25 to 30 degrees.

5. The apparatus of claim 3 wherein the soil motivators comprise rotatable shafts with a plurality of paddles attached thereto.

6. The apparatus of claim 5 wherein the paddles are symmetrically disposed around said rotatable shafts.

7. The apparatus of claim 5 wherein the paddles extend radially outward from the shafts in pairs.

8. The apparatus of claim 7 wherein adjacent pairs of paddles are perpendicular to each other.

9. The apparatus of claim 5 wherein the paddles are oriented so that when said shafts are rotated in a forward sense, said paddles move soil towards said discharge opening.

10. The apparatus of claim 8 wherein the paddles are oriented so that when said shafts are rotated in a forward sense, said paddles move soil towards said discharge opening.

11. The apparatus of claim 3 wherein the vessels comprise cylindrical drums.

12. The apparatus of claim 11 wherein the first end of at least one of the drums is closed and the second end of at least one of the drums is open.

13. The apparatus of claim 11 wherein the motivator in at least one of said drums comprises a screened cylinder attached to a rotatable shaft, said screened cylinder having a plurality of paddles therein.

14. The apparatus of claim 13 wherein the drainage system for said at least one of said drums comprises a plurality of slots on the underside of said at least one of said drums.

15. The apparatus of claim 11 wherein at least one of said cylindrical drums comprises a rearward portion and a forward portion, said forward portion having a diameter greater than a diameter of said rearward portion, and wherein said paddles in said forward portion have a screened cylinder attached to the outermost portions thereof.

16. The apparatus of claim 1 wherein the drainage system comprises at least one slot on an underside of at least one of said vessels.

17. The apparatus of claim 1 wherein the drainage system comprises a screened portion on an underside of at least one of said vessels.

18. The apparatus of claim 17 wherein the screened portion is adjacent to the discharge opening.

19. The apparatus of claim 18 wherein the screened portion has a mesh size in the range of 20 to 80 mesh.

20. The apparatus of claim 12 wherein the drainage system comprises a screened portion on an underside of at least one of said drums.

21. The apparatus of claim 20 wherein the screened portion is adjacent the second end.

22. The apparatus of claim 21 wherein the screened portion has a mesh size in the range of 20 to 80 mesh.

23. The apparatus of claim 21 wherein the drainage system further comprises at least one slot on at least one of the drums.

24. The apparatus of claim 23 wherein the slot is oriented generally horizontally along a side of said drum, said slot extending from said screened portion towards said first end.

25. The apparatus of claim 5 wherein said paddles have replaceable wear plates attached thereon.

26. The apparatus of claim 11, the apparatus further comprising a trailer having an intake conveyor and a discharge conveyor mounted thereon, wherein said drums are positioned on said trailer so that said intake conveyor deposits soil into a first of said drums, and soil exiting a last of said drums is deposited on said discharge conveyor.

27. The apparatus of claim 1 wherein the drainage system comprises a skimming system, the skimming system comprising a gutter and skimming plates, wherein said skimming plates are positioned in said gutter so that said liquid and said contaminants delivered to said gutter flows over said skimming plates, and soil mixed in with said liquid and said contaminants is caught by said skimming plates.

28. A vessel for treatment of soil that contains contaminants, the vessel comprising:
a cylindrical drum having a soil intake opening and a soil discharge opening;
a soil motivator operable to move soil through said vessel from said intake opening to said discharge opening; and
a liquid delivery system configured to deliver a liquid into said cylindrical drum;
wherein the vessel is inclined at an angle between 10 and 40 degrees so that the intake opening is at a lower level than the discharge opening.

29. The vessel of claim 28 further comprising a drainage system configured to collect said liquid and said contaminants.

30. The vessel of claim 28 wherein said soil motivator comprises a rotatable shaft with a plurality of paddles attached thereto.

31. The vessel of claim 30 wherein said cylindrical drum comprises a rearward portion and a forward portion, said forward portion having a diameter greater than a diameter of said rearward portion, and wherein said paddles in said forward portion have a screened cylinder attached to the outermost portions thereof.

32. The vessel of claim 31 wherein the drainage system comprises a plurality of generally circumferential slots in an underside of said forward portion.

33. An apparatus for treatment of soil that contains contaminants, the apparatus comprising:
at least four cylindrical drums, each of said drums having a soil intake opening and a soil discharge opening, said drums positioned at an incline so that the intake opening is at a lower level than the discharge opening, and said drums arranged in sequence so that soil discharged from the discharge opening of one of said drums falls into the intake opening of the next said drum, each of said drums other than a first of said drums having a liquid removal system in a forward portion thereof;
a soil motivator associated with each of said drums, said motivators operable to move soil through the associated drum from said intake opening to said discharge opening;
a liquid delivery system configured to deliver a first liquid cleaning agent into the first of said drums, a second liquid cleaning agent into another of said drums subsequent to said first drum, and water into the rest of said drums, and
a drainage system configured to collect liquids and said contaminants escaping from said liquid removal systems.

34. A method for treating soil that contains contaminants, the method comprising:
introducing the contaminated soil into a first vessel;
washing the soil with a first liquid cleaning agent;
passing the soil through a plurality of vessels in sequence wherein said first liquid cleaning agent is removed by a second liquid cleaning agent and water;
draining said second liquid cleaning agent and water from the soil; and
rinsing the soil with water.

35. A method of treating soil that contains contaminants, the method comprising:
introducing the contaminated soil and a first liquid chemical into a first vessel, said first vessel having an intake opening through which said soil is inserted, and a discharge opening;
agitating the soil and the first liquid chemical in said first vessel;
discharging the soil and a portion of the first liquid chemical from said discharge opening of said first vessel directly into an intake opening of a second vessel;
introducing water into said second vessel along with the soil and said portion of the first liquid chemical;
agitating the soil, said portion of the first liquid chemical and the water in said second vessel;
draining said portion of the first liquid chemical and the water from said second vessel;
discharging the soil from a discharge opening in said second vessel directly into an intake opening of a third vessel;
introducing a second liquid chemical and more water into said third vessel along with the soil;
agitating the soil, said second liquid chemical and water in said third vessel;
draining said second liquid chemical and water from said third vessel;
discharging the soil from a discharge opening in said third vessel directly into an intake opening of a rinsing vessel;
rinsing the soil in said rinsing vessel;
discharging the soil into a final vessel; and
separating water from the soil in said final vessel.
